(19) United States
(12) Patent Application Publication
(10) Pub. No.: US 2019/0089471 A1
(43) Pub. Date: Mar. 21, 2019

(54) SYSTEM AND METHOD FOR MMWAVE MASSIVE ARRAY SELF-TESTING

(71) Applicant: QUALCOMM Incorporated, San Diego, CA (US)

(72) Inventors: Javier Frydman, Tel-Mond (IL); Shai Provizor, Givat Ada (IL)

(21) Appl. No.: 15/711,551

(22) Filed: Sep. 21, 2017

(51) Int. Cl. H04B 17/29; H04B 17/15; H04B 17/30

(52) U.S. Cl. CPC H04B 17/29; H04B 17/30; H04B 17/15

(57) ABSTRACT

Techniques are disclosed for testing transceiver devices. A test controller is operatively coupled to a plurality of transceiver ports, coupled with waveguide interfaces. The test controller transmits a test signal via the interface from a first selected transceiver port, determines a characteristic of the test signal received at a second selected transceiver port, and determines whether the first or second selected transceiver port is coupled to an expected transceiver based on the characteristic of the test signal. Secondary or multiway interfaces may be used for other transceiver ports to transmit a second test signal to determine, based on the characteristics of the second test signal, whether the other transceiver ports are properly configured as source and destination ports.

### FIELD

This disclosure relates generally to techniques and technologies for providing self-testing capabilities in antenna arrays. More specifically, the present disclosure is directed to millimeter-wave (mmWave) massive array production line assembly self-test using over-the-air loop propagation delay line measurement.

### BACKGROUND

Due to the large bandwidth available, millimeter-wave (mmWave) radio, particularly that operating in the frequency range of 28 to 90 GHz, has been considered a particularly useful technology for 5G cellular communications. Compared to microwave systems, however, the propagation attenuation of mmWave is much higher, and the radiation power achievable is much lower. Accordingly, it is necessary to use high-directivity antennas to ensure that sufficiently high signal power can be received for successful signal detection. Furthermore, to support mobile users and users at different locations, mmWave radio often uses steerable directional antennas or configurable antenna arrays. Due to the small wavelength of mmWave, it is possible to accommodate a large number of antenna modules in a physically limited space. As such, for mm-Wave cellular communications, massive antenna array is becoming increasingly popular.

During mmWave massive array assembly, each antenna module is connected to a specific port in the motherboard card during assembly line production. However, it is not uncommon for two or more antenna modules to be connected erroneously to a port, which causes subsequent performance degradation in the beam-forming of the array. Currently, detecting such errors in the production line is difficult and expensive, as this process requires significant labor and specialized test equipment. For example, a production line worker would have to check the connections manually for each transmitting module being manufactured. Other approaches include specialized test equipment configured to test all or a subset of sample transmitting modules. Accordingly, there is a need to provide self-testing of mmWave circuitry to minimize or prevent such problems, among others.

### SUMMARY

Certain aspects of the present disclosure provide an apparatus for wireless communication, comprising: a processing system configured to generate a signal; and an interface configured to output the signal to a first port, and obtain the signal from a second port; wherein the processing system is further configured to generate an indication of at least one of whether the first port is correctly coupled to a first transceiver or whether the second port is correctly coupled to a second transceiver based on a characteristic of the obtained signal.

Certain aspects of the present disclosure provide a method for wireless transmission, comprising: generating a signal; outputting the signal to a first port; obtaining the signal from a second port; and generating an indication of at least one of whether the first port is correctly coupled to a first transceiver or whether the second port is correctly coupled to a second transceiver based on a characteristic of the obtained signal.

Certain aspects of the present disclosure provide an apparatus for wireless communication, comprising means for generating a signal; means for outputting the signal to a first port; means for obtaining the signal from a second port; and means for generating an indication of at least one of whether the first port is correctly coupled to a first transceiver or whether the second port is correctly coupled to a second transceiver based on a characteristic of the obtained signal.

Certain aspects of the present disclosure provide a computer-readable medium comprising a computer program for an apparatus for wireless communication, the computer program comprising a routine of set instructions for causing the apparatus to perform the steps of: generating a signal; outputting the signal to a first port; obtaining the signal from a second port; and generating an indication of at least one of whether the first port is correctly coupled to a first transceiver or whether the second port is correctly coupled to a second transceiver based on a characteristic of the obtained signal.

Certain aspects of the present disclosure provide a wireless node, comprising a processing system configured to generate a signal; a first transceiver configured to receive the signal via a first port, and transmit the signal; and a second transceiver configured to receive the transmitted signal; and send the received signal to a second port; wherein the processing system is further configured to obtain the signal from the second port and generate an indication of at least one of whether the first port is correctly coupled to the first transceiver or whether the second port is correctly coupled to the second transceiver based on a characteristic of the obtained signal.

Aspects of the present disclosure also provide various methods, means, and computer program products corresponding to the apparatuses and operations described herein.

### BRIEF DESCRIPTION OF THE DRAWINGS

FIG. 1 illustrates a block diagram of an exemplary wireless communication system in accordance with an aspect of the present disclosure;

FIG. 2 illustrates a block diagram of an exemplary access point and user terminal in accordance with another aspect of the present disclosure;

FIG. 3 illustrates a schematic block diagram of a transceiver utilizing massive array baseband-antenna module connectivity;

FIG. 4 illustrates a schematic block diagram of a transceiver utilizing massive array baseband-antenna module connectivity including a test controller and a test port with another aspect of the present disclosure;

FIG. 5 illustrates a set of antennas organized in an array with another aspect of the present disclosure;

FIG. 6A illustrates an exemplary waveguide configuration with another aspect of the present disclosure;

FIG. 6B illustrates another exemplary waveguide configuration with another aspect of the present disclosure;

FIG. 7A illustrates a flow diagram of an exemplary method for testing the connectivity of motherboard ports using a customized waveguide structure with another aspect of the present disclosure;

FIG. 7B continues the flow diagram of FIG. 7A of the exemplary method for testing the connectivity of motherboard ports using a customized waveguide structure;

FIG. 8 illustrates a four-way waveguide, having different lengths and attenuations between each pair to end points for testing the connectivity of motherboard ports with another aspect of the present disclosure;

FIG. 9 illustrates a flow diagram of an exemplary method for testing the connectivity of motherboard ports using the structure of FIG. 8 with another aspect of the present disclosure; and

FIG. 10 illustrates another flow diagram of an exemplary method for testing the connectivity of motherboard ports using the structure of FIG. 8 with another aspect of the present disclosure;

FIG. 11 illustrates a diagram of means for testing the connectivity of motherboard ports using the structure of FIG. 8 with another aspect of the present disclosure;

FIG. 12 illustrates an exemplary device utilizing a self-testing transceiver with another aspect of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple access terminals. A TDMA system may allow multiple access terminals to share the same frequency channel by dividing the transmission signal into different time slots, each time slot being assigned to different access terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

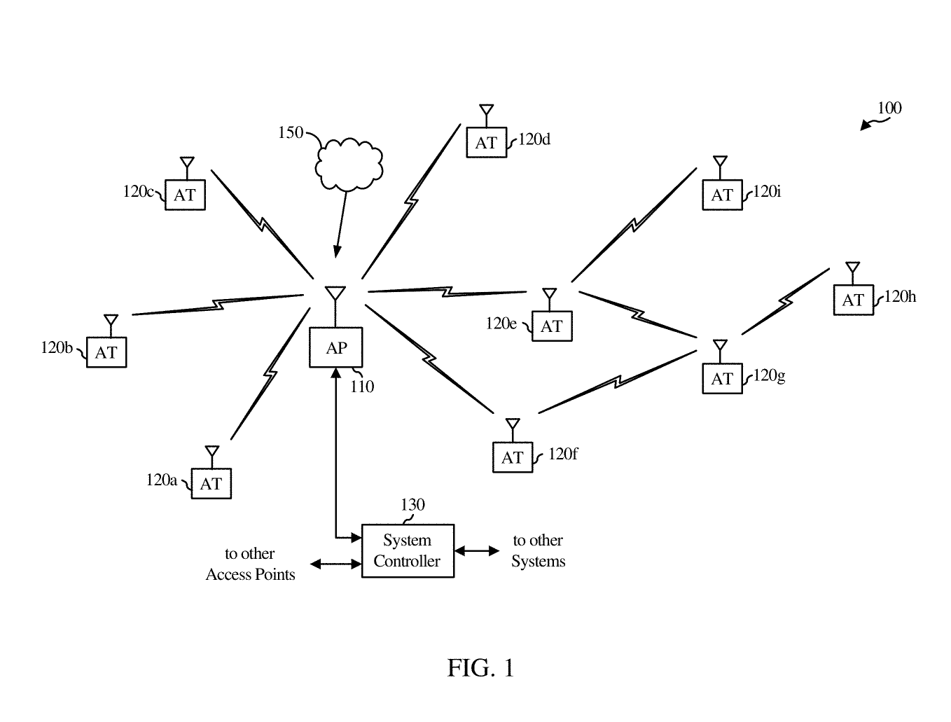

FIG. 1 illustrates a block diagram of an exemplary wireless communication system 100 with a plurality of wireless nodes, such as access points (APs) and access terminals (ATs). For simplicity, only one access point 110 is shown. An access point is generally a fixed station that communicates with access terminals and may also be referred to as a base station or some other terminology. An access terminal may be fixed or mobile, and may be referred to as a mobile station, a wireless device or some other terminology. The access point 110 may communicate with one or more access terminals 120a to 120i at any given moment on the downlink and uplink. The downlink (i.e., forward link) is the communication link from the access point to the access terminals, and the uplink (i.e., reverse link) is the communication link from the access terminals to the access point. An access terminal may also communicate peer-to-peer with another access terminal. A system controller 130 couples to and provides coordination and control for the access points. The access point 110 may communicate with other devices coupled to a backbone network 150.

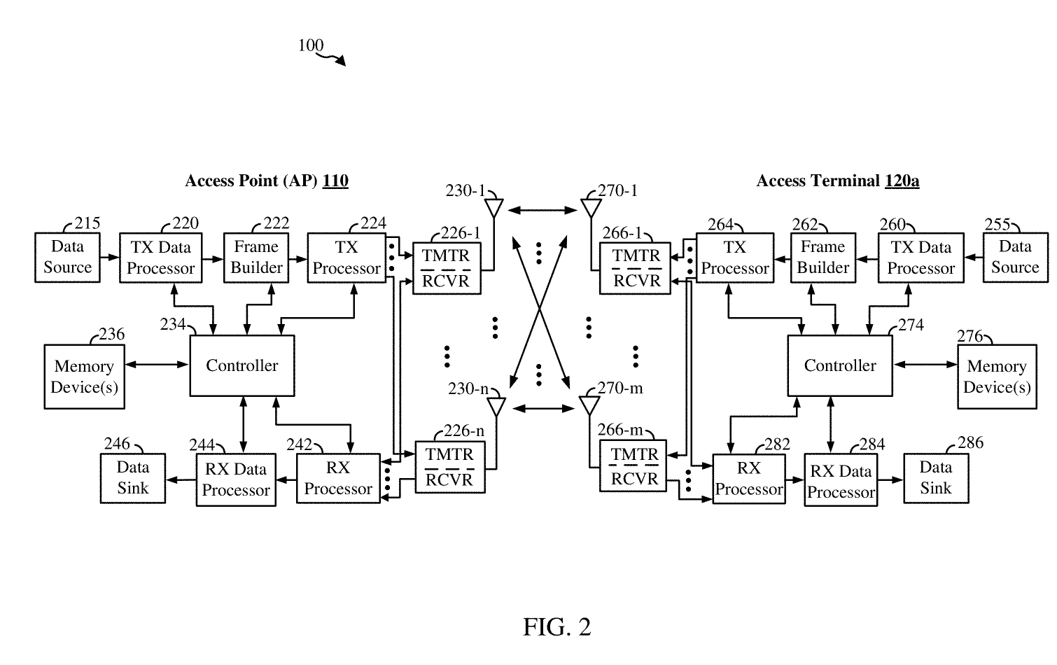

FIG. 2 illustrates a block diagram of the access point 110 (generally, a first wireless node) and an access terminal, for example, one of the access terminals 120a (generally, a second wireless node) in the wireless communication system 100. The access point 110 is a transmitting entity for the downlink and a receiving entity for the uplink. The access terminal 120a is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel.

For transmitting data, the access point 110 comprises a transmit data processor 220, a frame builder 222, a transmit processor 224, a plurality of transceivers 226-1 through 226-n, a bus interface for connecting the illustrated devices and components, and a plurality of antennas 230-1 through 230-n. The access point 110 also comprises a controller 234 for controlling operations of the access point 110.

In operation, the transmit data processor 220 receives data (e.g., data bits) from a data source 215, and processes the data for transmission. For example, the transmit data processor 220 may encode the data (e.g., data bits) into encoded data, and modulate the encoded data into data symbols. The transmit data processor 220 may support different modulation and coding schemes (MCSs). For example, the transmit data processor 220 may encode the data (e.g., using low-density parity check (LDPC) encoding) at any one of a plurality of different coding rates. Also, the transmit data processor 220 may modulate the encoded data using any one of a plurality of different modulation schemes, including, but not limited to, binary phase-shift keying (BPSK), quadrature phase-shift keying (QPSK), quadrature amplitude modulation (QAM) (for example, 16QAM, 64QAM, and 256QAM), and amplitude and phase-shift keying or asymmetric phase-shift keying (APSK) (for example, 64APSK, 128APSK, and 256APSK).

In certain aspects, the controller 234 may send a command to the transmit data processor 220 specifying which modulation and coding scheme (MCS) to use (e.g., based on channel conditions of the downlink), and the transmit data processor 220 may encode and modulate data from the data source 215 according to the specified MCS. It is to be appreciated that the transmit data processor 220 may perform additional processing on the data such as data scrambling, and/or other processing. The transmit data processor 220 outputs the data symbols to the frame builder 222.

The frame builder 222 constructs, or generates, a frame (also referred to as a packet), and inserts the data symbols into a data payload of the frame. The frame may include a preamble, a header, and the data payload. The preamble may include a short training field (STF) sequence and a channel estimation field (CEF) sequence to assist the access terminal 120a in receiving the frame. The header may include information related to the data in the payload such as the length of the data and the MCS used to encode and modulate the data. This information allows the access terminal 120a to demodulate and decode the data. The data in the payload may be divided among a plurality of blocks, wherein each block may include a portion of the data and a guard interval (GI) to assist the receiver with phase tracking. The frame builder 222 outputs the frame to the transmit processor 224.

The transmit processor 224 processes the frame for transmission on the downlink. For example, the transmit processor 224 may support different transmission modes such as an orthogonal frequency-division multiplexing (OFDM) transmission mode and a single-carrier (SC) transmission mode. In this example, the controller 234 may send a command to the transmit processor 224 specifying which transmission mode to use, and the transmit processor 224 may process the frame for transmission according to the specified transmission mode. The transmit processor 224 may apply a spectrum mask to the frame so that the frequency constituent of the downlink signal meets certain spectral requirements.

In certain aspects, the transmit processor 224 may support multiple-output-multiple-input (MIMO) transmission. In these aspects, the access point 110 may include multiple antennas 230-1 through 230-n and multiple transceivers 226-1 through 226-n (e.g., one for each antenna). The transmit processor 224 may perform spatial processing on the incoming frames and provide a plurality of transmit frame streams for the plurality of antennas. The transceivers 226a-1 through 226-n receive and processes (e.g., converts to analog, amplifies, phase shifts, filters, and frequency upconverts) the respective transmit frame streams to generate transmit signals for transmission via the antennas 230-1 through 230-n, respectively.

For transmitting data, the access terminal 120a comprises a transmit data processor 260, a frame builder 262, a transmit processor 264, at least one transceiver 266-1 through 266-m (where m may be one (1)), a bus interface for connecting the illustrated devices and components, and at least one antenna 270-1 through 270-m (e.g., one antenna per transceiver). The access terminal 120a may transmit data to the access point 110 on the uplink, and/or transmit data to another access terminal (e.g., for peer-to-peer communication). The access terminal 120a also comprises a controller 274 for controlling operations of the access terminal 120a.

In operation, the transmit data processor 260 receives data (e.g., data bits) from a data source 255, and processes (e.g., encodes and modulates) the data for transmission. The transmit data processor 260 may support different MCSs. For example, the transmit data processor 260 may encode the data (e.g., using LDPC encoding) at any one of a plurality of different coding rates, and modulate the encoded data using any one of a plurality of different modulation schemes, including, but not limited to, BPSK, QPSK, 16QAM, 64QAM, 64APSK, 128APSK, 256QAM, and 256APSK. In certain aspects, the controller 274 may send a command to the transmit data processor 260 specifying which MCS to use (e.g., based on channel conditions of the uplink), and the transmit data processor 260 may encode and modulate data from the data source 255 according to the specified MCS. It is to be appreciated that the transmit data processor 260 may perform additional processing on the data. The transmit data processor 260 outputs the data symbols to the frame builder 262.

The frame builder 262 constructs, or generates a frame, and inserts the received data symbols into a data payload of the frame. The frame may include a preamble, a header, and the data payload. The preamble may include an STF sequence and a CEF sequence to assist the access point 110 and/or other access terminal in receiving the frame. The header may include information related to the data in the payload such as the length of the data and the MCS used to encode and modulate the data. The data in the payload may be divided among a plurality of blocks where each block may include a portion of the data and a guard interval (GI) assisting the access point and/or other access terminal with phase tracking. The frame builder 262 outputs the frame to the transmit processor 264.

The transmit processor 264 processes the frame for transmission. For example, the transmit processor 264 may support different transmission modes such as an OFDM transmission mode and an SC transmission mode. In this example, the controller 274 may send a command to the transmit processor 264 specifying which transmission mode to use, and the transmit processor 264 may process the frame for transmission according to the specified transmission mode. The transmit processor 264 may apply a spectrum mask to the frame so that the frequency constituent of the uplink signal meets certain spectral requirements.

The transceivers 266-1 through 266m receive and process (e.g., converts to analog, amplifies, phase shifts, filters, and frequency upconverts) the output of the transmit processor 264 for transmission via the one or more antennas 270a through 270n. For example, the transceiver 266 may up-convert the output of the transmit processor 264 to a transmit signal having a frequency in the 60 GHz range.

In certain aspects, the transmit processor 264 may support multiple-output-multiple-input (MIMO) transmission. In these aspects, the access terminal 120 may include multiple antennas 270-1 through 270-m (where m>1) and multiple transceivers 266-1 through 266-m (e.g., one for each antenna). The transmit processor 264 may perform spatial processing on the incoming frame and provide a plurality of transmit frame streams for the plurality of antennas 270-1 through 270-m. The transceivers 266-1 through 266-m receive and process (e.g., converts to analog, amplifies, phase shifts, filters, and frequency upconverts) the respective transmit frame streams to generate transmit signals for transmission via the antennas 270-1 through 270-m.

For receiving data, the access point 110 comprises a receive processor 242, and a receive data processor 244. In operation, the transceivers 226-1 through 226-n receive a signal (e.g., from the access terminal 120a), and spatially process (e.g., frequency down-converts, amplifies, phase shifts, filters and converts to digital) the received signal.

The receive processor 242 receives the outputs of the transceivers 226-1 through 226-n, and processes the outputs to recover data symbols. For example, the access point 110 may receive data (e.g., from the access terminal 120a) in a frame. In this example, the receive processor 242 may detect the start of the frame using the STF sequence in the preamble of the frame. The receiver processor 242 may also use the STF for automatic gain control (AGC) adjustment. The receive processor 242 may also perform channel estimation (e.g., using the CEF sequence in the preamble of the frame) and perform channel equalization on the received signal based on the channel estimation.

Further, the receiver processor 242 may estimate phase noise using the guard intervals (GIs) in the payload, and reduce the phase noise in the received signal based on the estimated phase noise. The phase noise may be due to noise from a local oscillator in the access terminal 120a and/or noise from a local oscillator in the access point 110 used for frequency conversion. The phase noise may also include noise from the channel. The receive processor 242 may also recover information (e.g., MCS scheme) from the header of the frame, and send the information to the controller 234. After performing channel equalization and/or phase noise reduction, the receive processor 242 may recover data symbols from the frame, and output the recovered data symbols to the receive data processor 244 for further processing.

The receive data processor 244 receives the data symbols from the receive processor 242 and an indication of the corresponding multi-scale control (MSC) scheme from the controller 234. The receive data processor 244 demodulates and decodes the data symbols to recover the data according to the indicated MSC scheme, and outputs the recovered data (e.g., data bits) to a data sink 246 for storage and/or further processing.

As discussed above, the access terminal 120a may transmit data using an OFDM transmission mode or a SC transmission mode. In this case, the receive processor 242 may process the receive signal according to the selected transmission mode. Also, as discussed above, the transmit processor 264 may support multiple-output-multiple-input (MIMO) transmission. In this case, the access point 110 includes multiple antennas 230-1 through 230-n and multiple transceivers 226-1 through 226-n (e.g., one for each antenna). Each transceiver receives and processes (e.g., frequency downconverts, amplifies, phase shifts, filters, and converts to digital) the signal from the respective antenna. The receive processor 242 may perform spatial processing on the outputs of the transceivers 226-1 through 226-n to recover the data symbols.

For receiving data, the access terminal 120a comprises a receive processor 282, and a receive data processor 284. In operation, the at least one transceiver 266-1 through 266-m receive a signal (e.g., from the access point 110 or another access terminal) via the respective antennas 270-1 through 270-m, and process (e.g., frequency downconverts, amplifies, phase shifts, filters and converts to digital) the received signal.

The receive processor 282 receives the outputs of the transceivers 266-1 through 266-m, and processes the outputs to recover data symbols. For example, the access terminal 120a may receive data (e.g., from the access point 110 or another access terminal) in a frame, as discussed above. In this example, the receive processor 282 may detect the start of the frame using the STF sequence in the preamble of the frame. The receive processor 282 may also perform channel estimation (e.g., using the CEF sequence in the preamble of the frame) and perform channel equalization on the received signal based on the channel estimation.

Further, the receiver processor 282 may estimate phase noise using the guard intervals (GIs) in the payload, and reduce the phase noise in the received signal based on the estimated phase noise. The receive processor 282 may also recover information (e.g., MCS scheme) from the header of the frame, and send the information to the controller 274. After performing channel equalization and/or phase noise reduction, the receive processor 282 may recover data symbols from the frame, and output the recovered data symbols to the receive data processor 284 for further processing.

The receive data processor 284 receives the data symbols from the receive processor 282 and an indication of the corresponding MSC scheme from the controller 274. The receiver data processor 284 demodulates and decodes the data symbols to recover the data according to the indicated MSC scheme, and outputs the recovered data (e.g., data bits) to a data sink 286 for storage and/or further processing.

As discussed above, the access point 110 or another access terminal may transmit data using an OFDM transmission mode or a SC transmission mode. In this case, the receive processor 282 may process the receive signal according to the selected transmission mode. Also, as discussed above, the transmit processor 224 may support multiple-output-multiple-input (MIMO) transmission. In this case, the access terminal 120a may include multiple antennas and multiple transceivers (e.g., one for each antenna). Each transceiver receives and processes (e.g., frequency downconverts, amplifies, phase shifts, filters, and converts to digital) the signal from the respective antenna. The receive processor 282 may perform spatial processing on the outputs of the transceivers to recover the data symbols.

As shown in FIG. 2, the access point 110 also comprises a memory device(s) 236 coupled to the controller 234. The memory device(s) 236 may store instructions that, when executed by the controller 234, cause the controller 234 to perform one or more of the operations described herein. Similarly, the access terminal 120a also comprises a memory device(s) 276 coupled to the controller 274. The memory device(s) 276 may store instructions that, when executed by the controller 274, cause the controller 274 to perform the one or more of the operations described herein. The memory device(s) 236 and 276 may store data to assist the access point 110 and access terminal 120a in estimating interference at one or more neighboring devices, as described in more detail further herein.

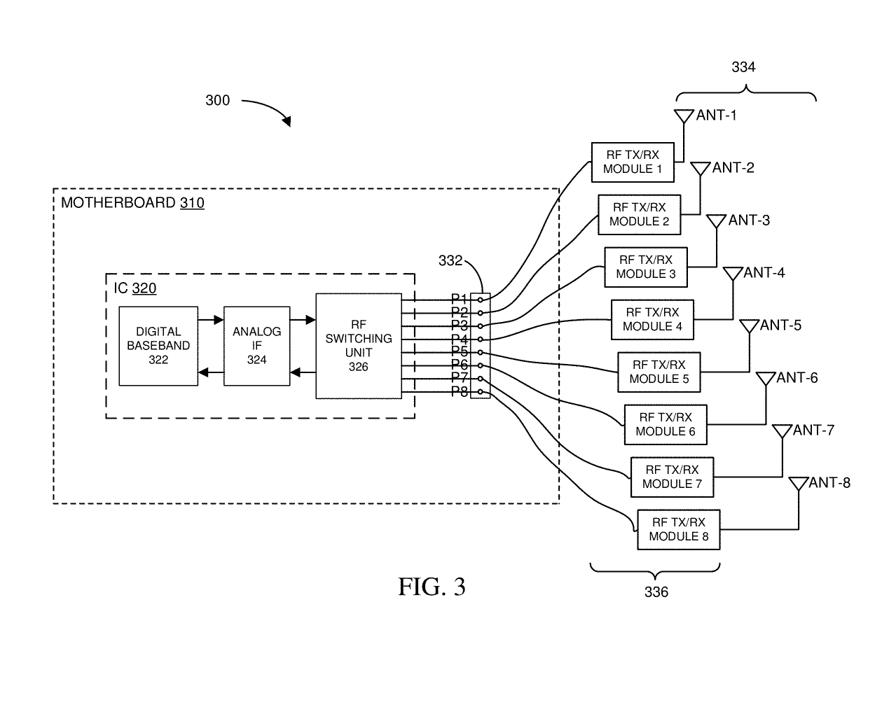

Turning now to FIG. 3, the drawing illustrates a schematic block diagram of an exemplary transceiver 300. From a manufacturing/assembly perspective, the transceiver 300 includes a motherboard 310 including a baseband (BB)/intermediate frequency (IF) IC 320. The IC 320 may include a digital baseband section, an analog IF unit 324, and an RF switching unit 326. The RF switching unit 326 of the IC 320 is coupled to a set of transceiver ports 332 (P1-P8) on the motherboard 310.

The transceiver 300 further includes a set of RF transceiver (Tx/Rx) modules 336 (modules 1-8) coupled to the set of ports 332 (P1-P8) via a set of transmission cables (e.g., XIF cables), respectively. The RF Tx/Rx modules 336 are coupled to a set of antennas 334 (ANT-1 through ANT-8), respectively.

The IC 320 may be configured to transmit and receive signals (e.g., frames or packets) to and from remote devices via the set of RF Tx/Rx modules 336 (modules 1-8) and antennas 334 (ANT-1 through ANT-8) in a directional manner In this regard, the IC 320 may be configured, in half-duplex mode, to send spatially-encoded signals to all of the RF Tx/Rx modules 336 for transmission via a specific beamforming profile. Similarly, the IC 320 may be configured, in half-duplex mode, to process spatially-encoded signals from all of the RF Tx/Rx modules 336 received via a specific beamforming profile. In full-duplex mode, half of the RF Tx/Rx modules 336 (e.g., modules 1-4) may be configured to transmit in a first directional manner, and the other half of the RF Tx/Rx modules (e.g., modules 5-8) may be configured to receive in a second directional manner or vice-versa. In the full-duplex mode, the second direction may be different than the first direction.

To achieve a desired beamforming, each of the ports 332 (P1-P8) should be connected to the appropriate RF Tx/Rx module 336 (ANT-1 through ANT-8). If, during manufacturing/assembly, the XIF cables connecting the ports 332 to the RF Tx/Rx modules 336 are not properly connected, then the desired beamforming would not result, leading to transmission and reception performance degradation.

Accordingly, technologies and techniques are illustrated in the present disclosure to minimize or eliminate such problems, among others. In illustrative embodiments, a transceiver system is disclosed utilizing multiple antenna modules, in which the system can define the module to transmit a signal. In some illustrative embodiments, the system is equipped with over-the-air loopback capabilities, wherein an antenna module can be configured to transmit a signal, and another antenna module can be configured to receive a signal simultaneously. During operation, the system may achieve high accuracy and resolution distance measurements capabilities, such as those defined in 802.11mc Fine Timing Measurement (FTM) flow. This flow requires systems to have the capability to configure a pair of RF transceiver modules for simultaneous transmission and reception of a test signal, respectively, and capture the Time Of Departure (TOD) and Time Of Arrival (TOA) of the test signal with an adequate degree of resolution. Using the technologies and techniques disclosed herein, a system may achieve, for example, 0.5 cm resolution. The disclosed production line self-test flow (i.e., without the need of specialized test equipment) can be designed to verify the correctness of the RF/Antenna modules connectivity by measuring the delay or propagation time (TOA-TOD) between two RF Tx/Rx modules, assisted with a known inter-antenna waveguide. Further details are provided in the figures and accompanying text, below.

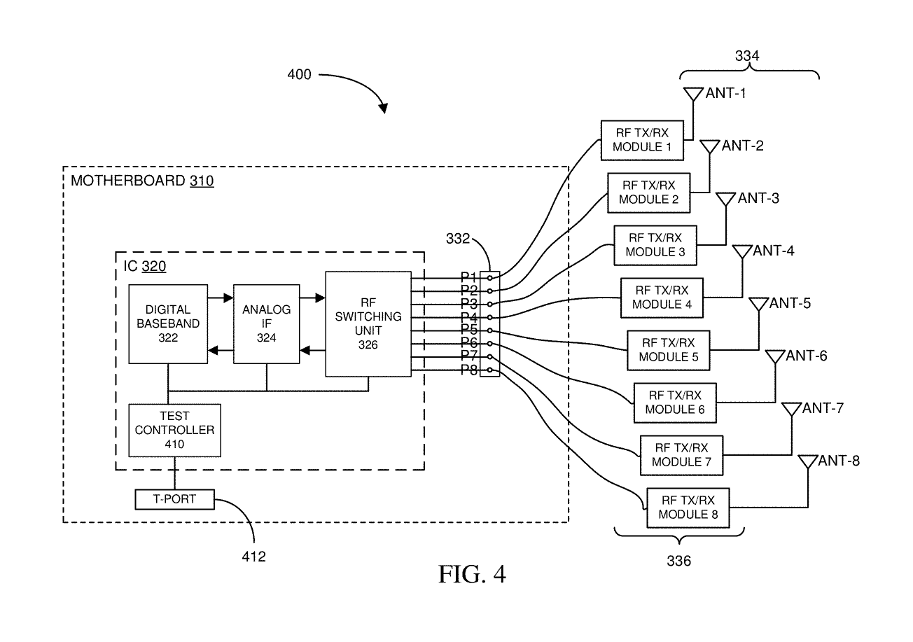

Turning to FIG. 4, the drawing illustrates a simplified schematic block diagram of an exemplary transceiver 400 in accordance with an aspect of the disclosure. Similarly, the transceiver 400 includes a motherboard 310, an IC 320 mounted on the motherboard 310, a set of RF Tx/Rx modules 336 (modules 1-8), and a set of corresponding antennas 334 (ANT-1 through ANT-8). As shown, the set of RF Tx/RX modules 336 are connected to a set of transceiver ports 332 (Pl-P8) on the motherboard 310 via a set of transmission cables, respectively. The set of ports 332 (P1-P8) are, in turn, connected to the RF switching unit 326 of the IC 320. The IC 320 further includes a digital baseband section 322 and an analog IF unit 324.

In some illustrative embodiments, for self-testing of the connectivity of the set of ports 332 to the RF Tx/Rx modules 336, the IC 320 may include a test controller 410 for controlling the digital baseband 322, analog IF unit 324, and RF switching unit 326 as further discussed herein. The transceiver 400 further includes a test port 412 operatively coupled to the test controller 410 of the IC 320 and mounted on the motherboard 310. During operation, a computer, or other suitable processing device, may be connected to the test port for initiating the self-test, receiving user prompts, and receiving the test results.

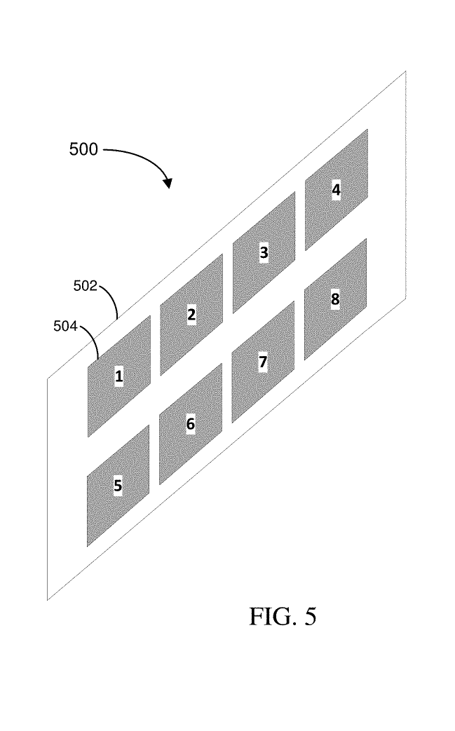

FIG. 5 illustrates a simplified perspective view of an antenna arrangement 500, where a plurality of antennas (504) is fabricated on a substrate 502. In this example, the antennas 504 are arranged in a 2×4 array (antennas 1-8). This configuration will be used to explain other embodiments disclosed herein, but, it should be understood by those skilled in the art that other configurations and antenna arrangements are possible and are contemplated by the present disclosure. In general, the present disclosure is applicable to any technology utilizing waveguide antenna arrays.

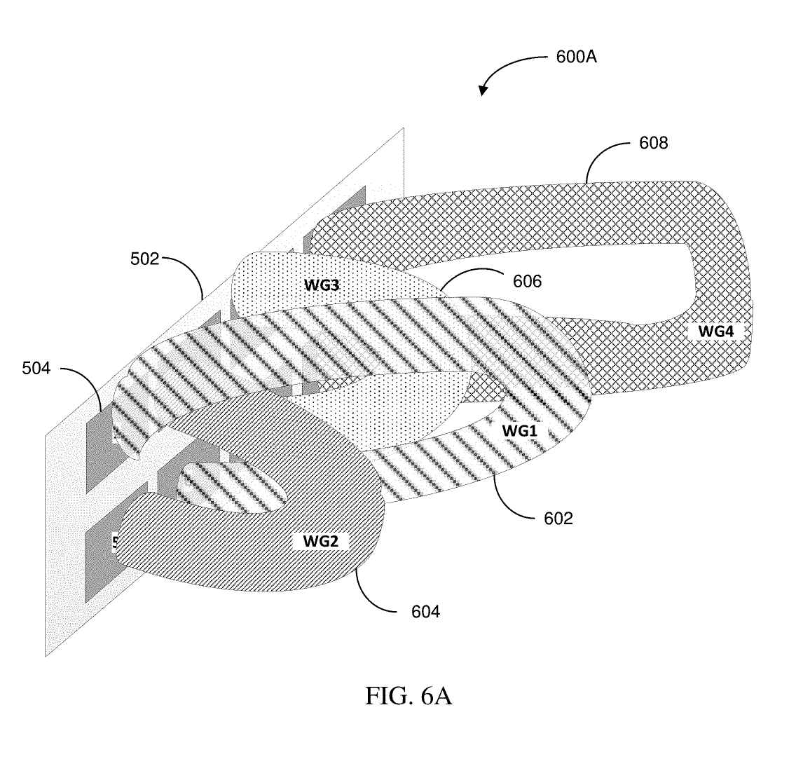

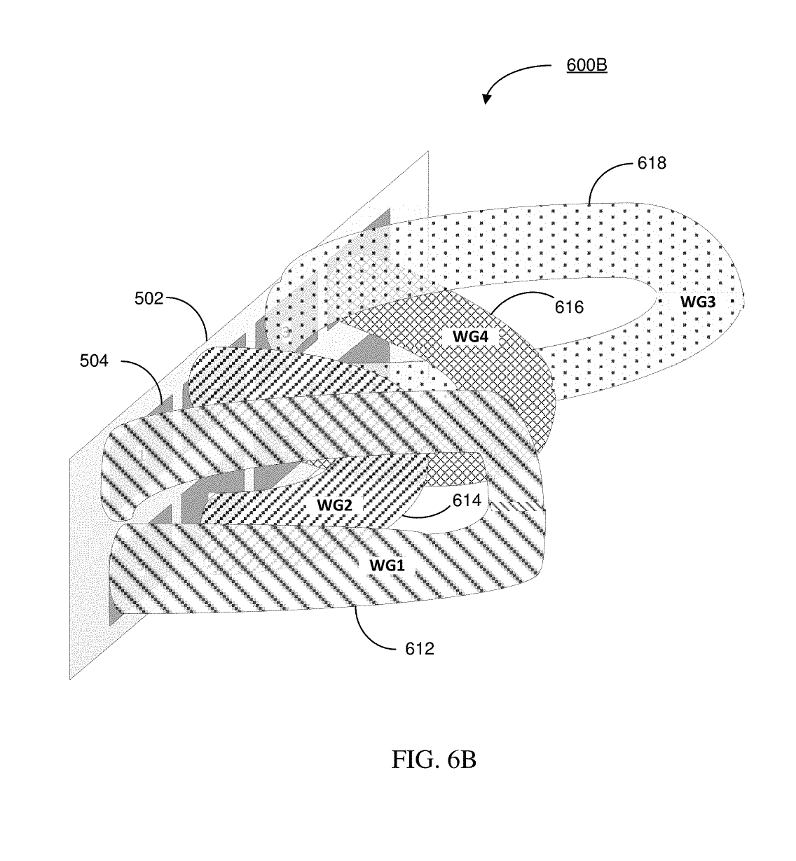

Turning now to FIG. 6A, the drawing illustrates a waveguide configuration 600A utilizing the antenna arrangement having the 2×4 array of antennas (504) on the substrate 502 under an illustrative embodiment. In this example, antenna pairs are connected to each other via waveguides. As can be seen in the figure, the waveguide configuration 600A includes a set of four waveguides WG1, WG2, WG3, and WG4 (602-608), which may be securely attached (e.g., glued) to each other to form an integral waveguide configuration. Here, waveguide WG1 is arranged to connect antenna 1 and antenna 6 together. Waveguide WG2 is arranged to connect antenna 2 and antenna 5 together. Waveguide WG3 is arranged to connect antenna 3 and antenna 7 together. Furthermore, waveguide WG4 is arranged to connect antenna 4 and antenna 8 together. In some illustrative embodiments, the waveguides WG1, WG2, WG3, and WG4 are configured to have distinct lengths L1, L2, L3, and L4, respectively. Table 1 summarizes the test connection of the waveguide configuration 600A to the antennas 1-8:

TABLE 1

| Wave Guide | Source | Destination | Length |
|---|---|---|---|
| 1 | 1 | 6 | L1 |
| 2 | 2 | 5 | L2 |
| 3 | 3 | 7 | L3 |
| 4 | 4 | 8 | L4 |

The self-testing of the present disclosure may be described as occurring over multiple phases or stages. The following describes a first phase of the testing the connectivity of the RF Tx/Rx modules 336 (modules 1-8) to the ports 332 (P1-P8) on the motherboard 310. In some illustrative embodiments, ports corresponding to antenna pairs may be configured such that one port transmits data test signal, while the other paired port receives the test signal, and the test controller (e.g., 410) determines characteristics of the transmitted/received test signal, such as the propagation delay TOA-TOD.

Continuing with the example of FIG. 6A, the connection of port P1 to RF Tx/Rx module 1 (see e.g., FIG. 4) may be first tested by the test controller (e.g., 410) by configuring the RF Tx/Rx module 1 for transmission and RF Tx/Rx module 6 for simultaneous reception. The test controller 410 is configured to causes a test signal (e.g., a packet or frame) to be transmitted, and subsequently records the time-of-departure (TOD) of the transmission of the test signal. If port P1 is correctly coupled to RF Tx/Rx module 1, the transmitted test signal propagates to the RF Tx/RX module 6 via the waveguide WG1, as can be seen in the figure. The test controller (e.g., 410) then records the time-of-arrival (TOA) of the test signal. As the length (L1) of the waveguide WG1 is predetermined prior to transmission, the propagation delay TOA-TOD of the test signal subsequently determined by the test controller should be consistent with the length (L1).

Further, in accordance with testing whether port P1 is correctly coupled to RF Tx/Rx module 1, some or all of the other RF Tx/Rx modules may be configured for reception. For example, RF Tx/Rx modules 2 and 5 may be configured for simultaneous reception if there is a limitation as to the number of RF Tx/Rx modules that may be configured for simultaneous reception, or the remaining RF Tx/Rx modules 2-5 and 7-8 may be configured for simultaneous reception if no such limitation exists. If, for example, port P1 is incorrectly wired to RF Tx/Rx module 2, then the test signal propagates via a different waveguide WG2, which has a different length (L2) than the length (L1) of waveguide WG1. Thus, if the test controller 410 determines that the propagation delay is not based on the length (L1) of waveguide WG1, but is instead based on the length (L2) of waveguide WG2, the test controller determines that port P1 is not correctly connected to RF Tx/Rx module 1. Accordingly, the test controller may determine whether the port P1 in this example is properly connected to RF Tx/Rx module 1 by determining whether the propagation delay TOA-TOD of the test signal.

Similarly, the connection of ports P2 to RF Tx/Rx module 2 is tested by the test controller (e.g., 410) by configuring the RF Tx/Rx module 2 for transmission and RF Tx/Rx module 5 for reception. The test controller 410 is configured to cause another test signal to be transmitted, and subsequently records the time-of-departure (TOD) of the transmission of the test signal. If port P2 is correctly connected to RF Tx/Rx module 2, the transmitted test signal propagates to the RF Tx/RX module 5 via the waveguide WG2, as can be seen in the figure. The test controller (e.g., 410) then records the time-of-arrival (TOA) of the test signal. As the length (L2) of the waveguide WG2 is predetermined prior to transmission, the propagation delay TOA-TOD subsequently determined by the test controller will be a function of that length (L2) if port P2 is correctly connected to RF Tx/RX module 2.

If, for example, port P1 is incorrectly wired to RF Tx/Rx module 3, then the test signal propagates via a different waveguide WG3, which has a different length (L3) than the length (L2) of waveguide WG2. Thus, if the test controller 410 determines that the propagation delay is not based on the length (L2) of waveguide WG2, but is instead based on the length (L3) of waveguide WG3, the test controller determines that port P2 is not correctly connected to RF Tx/Rx module 2. In an illustrative embodiment, L2 is different than L1. Accordingly, the test controller may determine whether the ports P2 and P5 in this example are properly connected to RF Tx/Rx modules 2 and 5 by determining whether the TOA-TOD is consistent with length L2 of waveguide WG2. The above process for processing and determining the connectivity of a port-to-RF Tx/Rx module is repeated in a similar manner for the remaining ports P3-P8.

The above first test phase can advantageously determine whether each port of a pair of ports is properly connected to the corresponding other port (e.g., P1/P6 to RF Tx/Rx modules 1/6). However, the present disclosure may be extended further to allow a system to resolve the ambiguity of the ports being incorrectly swapped among themselves. In other words, the first test phase may determine that the physical connection of port P1 to RF Tx/Rx module 6 and port P6 to RF Tx/Rx module 1 and port P1 as being correct. However, there may be ambiguity as to whether the each port is properly configured as a source/destination. To resolve the ambiguity, another waveguide configuration, connecting different pairs of ports (e.g., 332), may be connected to the antennas 334 (ANT-1 through ANT-8), and a second test phase may be performed.

FIG. 6B illustrates an exemplary waveguide configuration 600B in accordance with another aspect of the disclosure. The waveguide configuration 600B includes another different set of integrally-attached (e.g., glued together) four waveguides WG1, WG2, WG3, and WG4 (612-618) to achieve different routings between the antennas 1-8. For instance, in FIG. 6A, the waveguide configuration 600A includes waveguide WG1 coupling antenna 1 to antenna 6, waveguide WG2 coupling antenna 2 to antenna 5, waveguide WG3 coupling antenna 3 to antenna 6, and antenna 4 to antenna 8. In the case of waveguide configuration 600B shown in FIG. 6B, waveguide WG1 couples antenna 1 to antenna 5, waveguide WG2 couples antenna 2 to antenna 6, waveguide WG3 couples antenna 3 to antenna 8, and waveguide WG4 couples antenna 4 to antenna 7.

The different routing provided by the waveguide configuration 600B is to resolve ambiguity with a pair of ports connected to the correct pair of RF transceiver modules, but the connection is swapped. For example, ports P1 and P6 should be connected to RF transceiver modules 1 and 6, respectively. However, during manufacturing, ports P1 and P6 may be incorrectly connected to RF transceiver modules 6 and 1, respectively. If a test signal is sent to port P1, the test signal will be received via port 6, whereby RF transceiver modules 6 and antenna 6 transmitted the test signal and RF transceiver modules 1 and antenna 1 received the test signal. Further, because the correct waveguide WG1 is used to connect the two ports, the expected delay (TOA-TOD) is correct. Thus, even though ports P1 and P6 are incorrectly connected to RF transceiver modules 6 and 1, respectively, the received test signal indicates that the connection is correct.

Continuing the above example, using the second waveguide configuration 600B, the incorrect connection of ports P1 and P6 to RF transceiver modules 6 and 1 may be detected. For instance, according to the second waveguide configuration 600B, the waveguide WG1 couples antenna 1 to antenna 5. Thus, if a test signal is sent to port 1, and port 1 is incorrectly coupled to antenna 6, the test signal is propagates via the incorrect waveguide WG2 and not the correct waveguide WG1. Thus, in this example, the test controller 410 determines that ports P1 and P6 are incorrectly coupled to RF Tx/Rx transceiver modules 6 and 1, respectively. Thus, the different routing provided by the second waveguide configuration 600B is designed to reveal incorrect swapping of port pair to RF transceiver module pair.

TABLE 2

| Waveguide | Source | Destination | Length |
|---|---|---|---|
| 1 | 1 | 5 | L5 |
| 2 | 2 | 6 | L6 |
| 3 | 3 | 8 | L7 |
| 4 | 4 | 7 | L8 |

The second test phase is performed similar to the first test phase described above in connection with FIG. 6A. However, since the source/destination pairs are different in the second phase compared to the first phase, any erroneous swapping of source/destination ports will be detected. As such, the second test phase resolves the ambiguity of a pair of ports being correctly connected to a pair of RF Tx/Rx modules, but are swapped.

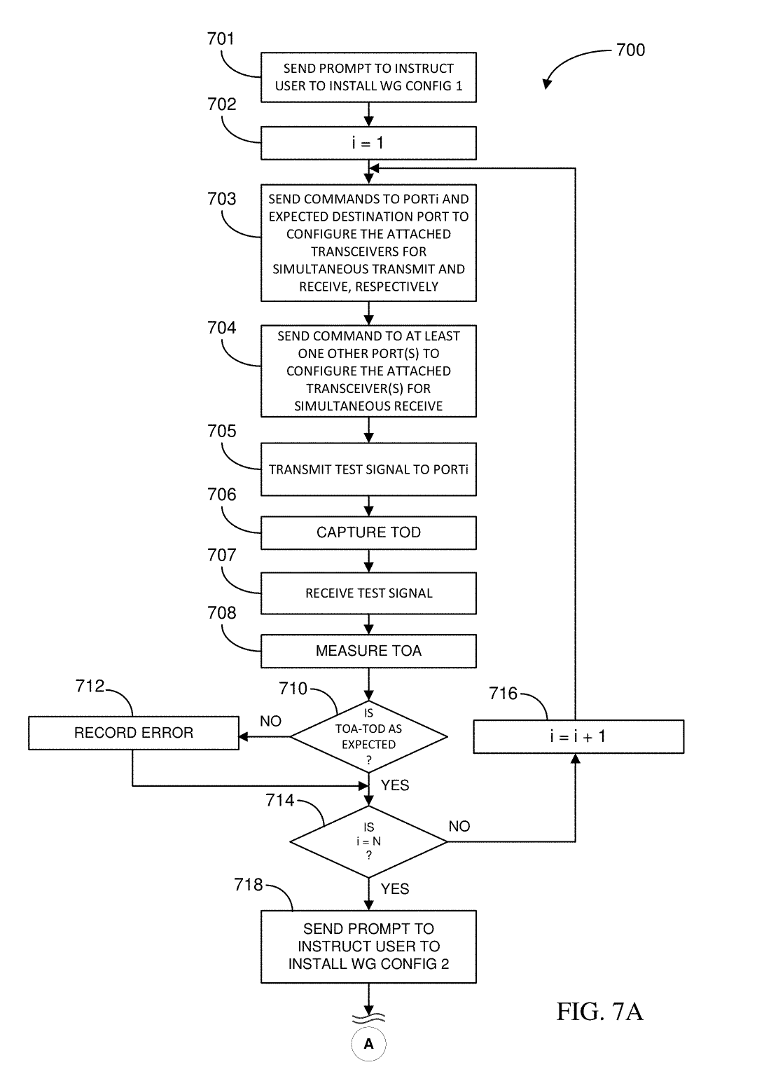

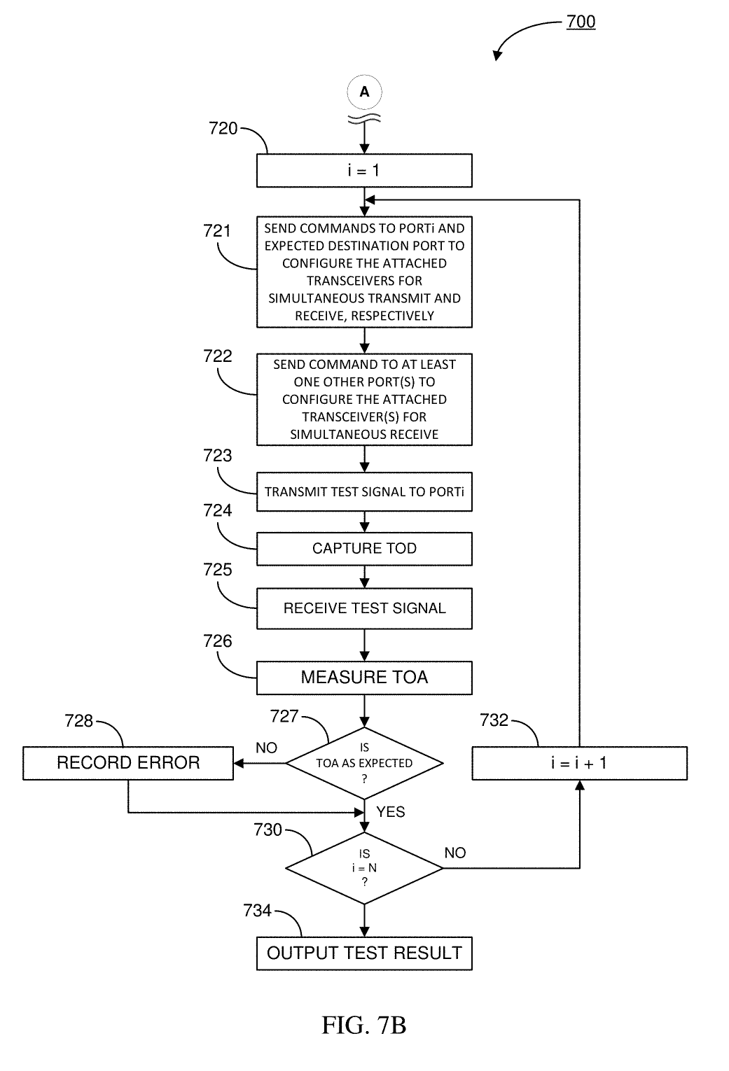

FIGS. 7A-7B illustrate a flow diagram of an exemplary method 700 of testing the connectivity of ports-to-RF Tx/Rx modules under an illustrative embodiment. The first phase of the test described above is shown in blocks 701 to 716, and the second phase of the test is described in blocks 718 to 734. Starting from block 701, a computer or other suitable processing device, such as the test controller 410, may instruct a user via the test port 412 to install a first waveguide configuration (e.g., 600A). In block 702, the test controller (e.g., 410) sets variable i to one (i=1) to indicate that the current port, (e.g., P1) whose connection to the expected RF Tx/RX module (e.g., RF Tx/Rx module 1) is to be tested.

In block 703, the test controller 410 sends commands to port, (e.g., P1) and the expected destination port (e.g., P6) to configure the attached transceivers for simultaneous transmission and reception, respectively. In block 704, the test controller 410 sends command to at least one other port(s) (e.g., P2 and P5) to configure the attached transceivers for simultaneous reception. In block 705, the test controller (e.g., 410) transmits a test signal (e.g., test packet) to port, (e.g., P1). In block 706, the test controller 410 records or captures the time-of-deliver (TOD) of the test signal. In block 707, the test controller 410 receives the test signal. In block 708, the test controller 410 then measures the time-of-arrival (TOA) of the test signal.

In decision block 710, the test controller then determines whether the propagation delay of the test signal (e.g., TOA-TOD) matches an expected propagation delay associated with the expected waveguide (e.g., WG1). In some illustrative embodiments, the test controller may be configured with a memory to store expected TOA-TOD values corresponding to specific waveguides to be used during testing. In some illustrative embodiments, a tolerance algorithm may be utilized in the test controller to allow certain measured TOA-TOD values that are within a predetermined margin (e.g., 10%). If, in decision block 710, the test controller 410 determines that the measured TOA-TOD does not match the stored, expected TOA-TOD (or is outside a margin of error), the process 700 continues to block 712, where the erroneous reading is recorded and proceeds to decision block 714 as shown. If decision block 710 determines that the measured TOA-TOD matches (or is within a margin of error), the process continues to decision block 714, where the test controller 410 determines if i=N. Here, N represents the total number of ports to be tested. Using the embodiments of FIG. 6A-6B as examples, N would be set to 8 (i.e., P1-P8).

If decision block 714 determines that i does not equal N, the process proceeds to block 716, where the i value is incremented (i+1). The process of FIG. 7A then moves to block 703, where the test controller (e.g., 410) sends commands to the next port, (e.g., P2) and the expected destination port (e.g., P5) to configure the attached transceivers for simultaneous transmission and reception, respectively. In block 704, the test controller 410 sends command to at least one other port(s) (e.g., P1 and P6) to configure the attached transceivers for simultaneous reception. Similarly, in block 705, the test controller 410 transmits another test signal (e.g., test packet) to port, (e.g., P2). In block 706, the test controller 410 records or captures the time-of-deliver (TOD) of the test signal. In block 707, the test controller 410 receives the test signal. In block 708, the test controller 410 then measures the TOA of the test signal.

Similarly, in decision block 710, the test controller 410 then determines whether the measured propagation delay (e.g., TOA-TOD) matches an expected TOA-TOD value of the associated with waveguide (e.g., WG2). If the test controller 410 determines that the measured TOA-TOD does not match the stored, expected TOA-TOD (or is outside a margin of error), the process 700 continues to block 712, where the erroneous reading is recorded and proceeds to decision block 714 as shown. If decision block 710 determines that the measured TOA-TOD matches (or is within a margin of error), the process continues to decision block 714, where the test controller (e.g., 410) determines if i=N. This process repeats until all remaining ports are tested, at which point i=N and the process continues to block 718. It should be understood by those skilled in the art that, while sequential incrementing of waveguides for testing is disclosed, other configurations, such as non-sequential or patterned testing of waveguides are contemplated in the present disclosure.

Once the final port is tested (i=N), the process continues to block 718, where the computer, or other suitable processing device, sends a prompt to instruct a user via the test port 412 to install a second waveguide configuration (e.g., 600B). The process then continued to block 720 of FIG. 7B. In block 720, the test controller 410 sets variable i to one (i=1) to indicate that the current port, (e.g., P1) whose connection to the expected RF Tx/RX module (e.g., RF Tx/Rx module 1) is to be tested. In block 721, the test controller 410 sends commands to port, (e.g., P1) and the expected destination port (e.g., P5) to configure the attached transceivers for simultaneous transmission and reception, respectively. In block 722, the test controller 410 sends command to at least one other port(s) (e.g., P2 and P6) to configure the attached transceivers for simultaneous reception. In block 723, the test controller (e.g., 410) transmits a test signal (e.g., test packet) to port, (e.g., P1). In block 724, the test controller 410 records or captures the time-of-deliver (TOD) of the test signal. In block 725, the test controller 410 receives the test signal. In block 726, the test controller 410 then measures the TOA of the test signal.

In decision block 727, the test controller 410 then determines whether the measured delay (e.g., TOA-TOD) matches an expected propagation delay associated with expected waveguide (e.g., WG1). If, in decision block 727, the test controller 410 determines that the measured TOA-TOD does not match the stored, expected TOA-TOD (or is outside a margin of error), the process 700 continues to block 728, where the erroneous reading is recorded and proceeds to decision block 730 as shown. If decision block 726 determines that the measured TOA-TOD matches (or is within a margin of error) the expected TOA-TOD, the process continues to decision block 730, where the test controller 410 determines if i=N. Again, N represents the total number of ports to be tested. Using the embodiments of FIG. 6A-6B as examples, N would be set to 8 (i.e., Pl-P8).

If decision block 727 determines that i does not equal N, the process proceeds to block 732, where the i value is incremented (i+1), and the process of FIG. 7B then proceeds through blocks 721-730 as discussed previously until all of the waveguides (e.g., WG1-WG4) have been tested (i=N). At this point the process continues to block 734, where the system outputs the test results, including any recorded errors obtained from blocks 712 and 728. It shall be understood that instead of recording the errors per blocks 712 and 728, the measured propagation TOA-TOD for each port may be recorded in a table. The test controller 410 may then examine the table to determine whether there are any port-to-transceiver connection errors, and output the report per block 734.

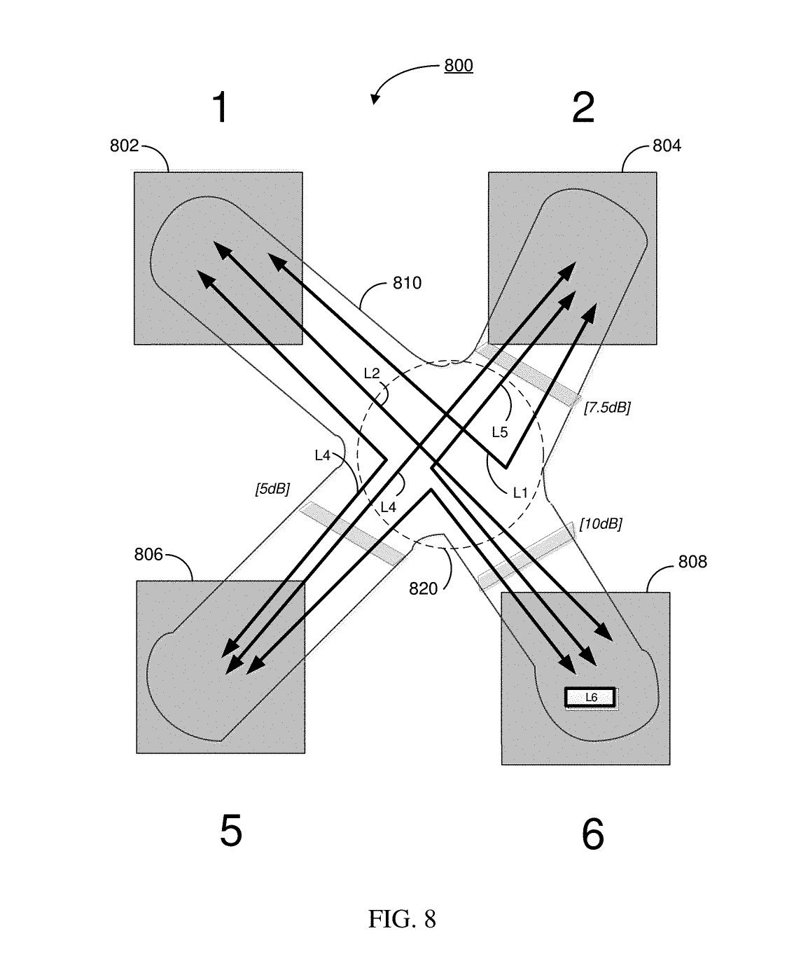

While the embodiments of FIGS. 6A-6B provide certain advantages, there may be circumstances or applications where the changing of waveguides (e.g., from 600A to 600B) during testing may not be optimal. Accordingly, FIG. 8 illustrates a multiway waveguide 800 that may be configured to perform the testing described herein using a single installation, and without the need for two test phases. The multiway waveguide structure 800 is shown in the example as a 4-way waveguide having a common central region 820. Those skilled in the art will recognize that other waveguide configurations (e.g., 6-way, 8-way, etc.) and waveguide physical and geometric structures are contemplated by the present disclosure.

Multiway waveguide 800 includes four waveguide (WG) ports 1, 2, 5, and 6 (802-806) coupled to 4 paths to the common central region 820, respectively. These WG ports 1, 2, 5, and 6 are coupled to antennas 1, 2, 5, and 6 for testing the connections to motherboard ports P1, P2, P5, and P6, respectively. For testing the connections to motherboard ports P3, P4, P7, and P8, another similar multiway waveguide may be used. For description simplicity, the multiway waveguide 800 for antennas 1, 2, 5, and 6 is described below. It shall be understood that the multiway waveguide for the other antennas 3, 4, 7, and 8 operate in a similar manner.

The multiway waveguide 800 may be configured such that the path from WG port 1 (802) to the central region 820 has no attenuation. Furthermore, the path from WG port 5 (805) to the central region 820 may be configured to have 5 dB attenuation, the path from WG port 2 (804) to the central region 820 may be configured to have 7.5 dB attenuation and the path from WG port 6 (808) to the central region 820 may be configured to have 10 dB attenuation. As discussed the WG ports 1, 2, 6, and 5 as shown in the figure may be configured to connect to four antennas, such as antennas 1, 2, 5, and 6 of FIG. 5. Is shall be understood that the above attenuation values are merely examples, and the waveguide 800 may be configured to provide another set of distinct attenuation values. Each of the individual waveguides paths may be configured to have specific length L1-L6, having a specific, cumulative attenuation along its path, as exemplified in Table 3:

TABLE 3

| Antenna 1 # | Antenna 2 # | Attenuation (dB) | Length |
|---|---|---|---|
| 1 | 2 | 7.5 | L1 |
| 1 | 6 | 10 | L2 |
| 1 | 5 | 5 | L3 |
| 2 | 5 | 12.5 | L4 |
| 2 | 6 | 17.5 | L5 |
| 6 | 5 | 15 | L6 |

The following describes the testing the connectivity of the RF Tx/Rx modules 1, 2, 5, and 6 to the ports P1, P2, P5, and P6 on the motherboard 310 using the embodiment of FIG. 8. As an example, the test controller 410 configures the RF Tx/Rx module coupled to port P1 for transmission, RF Tx/Rx module coupled to port P2 for reception, and disables the other RF Tx/Rx modules 5 and 6. The test controller 410 then causes a test signal (e.g., packet/frame) to be transmitted along the path and records the transmission power PTX of the test signal. The transmitted test signal propagates to the RF Tx/RX module coupled to port P2 via the multiway waveguide 800. The test controller 410 records the reception power PRX of the test frame. The difference PTX-PRX is a function of the attenuation through the multiway waveguide 800, which, if connected correctly, is approximately 7.5 dB (the cumulative attenuation between ports 1 and 2 of the multiway waveguide 800).

Next, the test controller (410) configures the RF Tx/Rx module coupled to port P1 for transmission, RF Tx/Rx module coupled to port P5 for reception, and disables the RF Tx/Rx modules 2 and 6. Then, the test controller 410 causes a test signal (e.g., packet, frame) to be transmitted, and records the transmission power PTX of the test signal. The transmitted test signal propagates to the RF Tx/RX module coupled to port P3 via the multiway waveguide 800. The test controller 410 records the reception power PRX of the test signal. The difference PTX-PRX is a function of the attenuation through the multiway waveguide 800, which, if connected correctly, is approximately 10 dB (the cumulative attenuation between ports 1 and 6 of the multiway waveguide 800). The process above repeats until all the receive ports are tested. In this example, the connection is correct if the receive power PRX is consistent with the expected attenuation through the waveguide structure of the multiway waveguide 800.

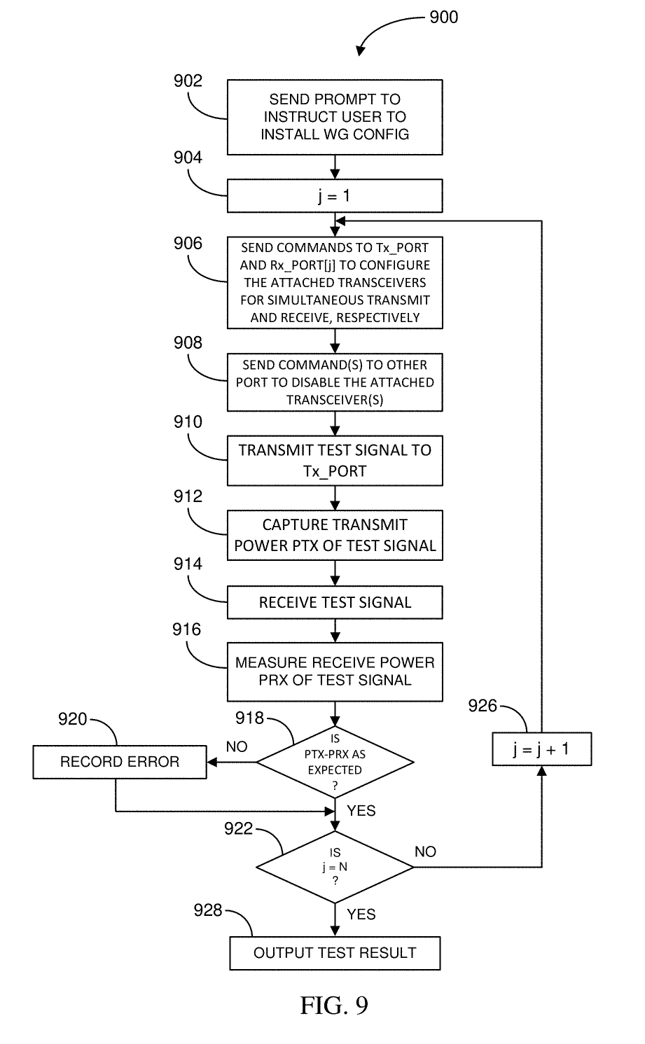

FIG. 9 illustrates a flow diagram of an exemplary method 900 of testing the connectivity of the motherboard ports to the RF Tx/Rx modules using multiway waveguide 800 described above. In this example, in block 902, a computer or other suitable processing device sends a prompt to instruct a user via the test port 412 to install the waveguide configuration (e.g., 800). Once installed, the test controller 410 sets variable j=2, where variable j represents the test signal receiving port index

Once the variable j is set, the method 900 proceeds to block 906, where the test controller 410 sends commands to a transmit port Tx_Port (e.g., P1) and a current receive port Rx_Port[j] (e.g., P2) to configure the attached transceivers for simultaneous transmission and reception, respectively. In block 908, the test controller 410 sends at least one command to at least one other port (e.g., port P5 and P6) to disable the attached RF Tx/Rx modules. In block 910, the test controller 410 transmits a test signal (e.g., packet, frame) to the transmit port Tx_Port (e.g., P1). In block 912, the test controller 410 records or captures the transmit power PTX of the test signal. In block 914, the test controller 410 receives the test signal. In block 916, the test controller 410 measures the receive power PRX of the test signal.

In decision block 918, the test controller 410 determines if the measured attenuation PTX-PRX matches the stored attenuation expected for the port pair. As in other embodiments described herein, the matching in decision block 918 may be an exact match, or may be subjected to a margin of error. If the measured attenuation does not match, the method proceeds to block 990, where the error is recorded in memory and the method proceeds to decision block 9922. If the measured attenuation matches in decision block 918, the method 900 continues to decision block 922, where the test controller determines if the receive port index j is the last receive port index N in the test sequence. If not, the method proceeds to block 926, where the test controller 410 increments the receive port current index j=j+1, and the method 900 proceeds through blocks 906-922 as previously discussed until. Once it is determined that all measurements are complete per decision block 922, the method proceeds to output the test results in block 928.

It shall be understood that instead of recording the errors per blocks 920, the measured attenuation PTX-PRX for each receive port may be recorded in a table. The test controller 410 may then examine the table to determine whether there are any port-to-transceiver connection errors, and output the report per block 928.

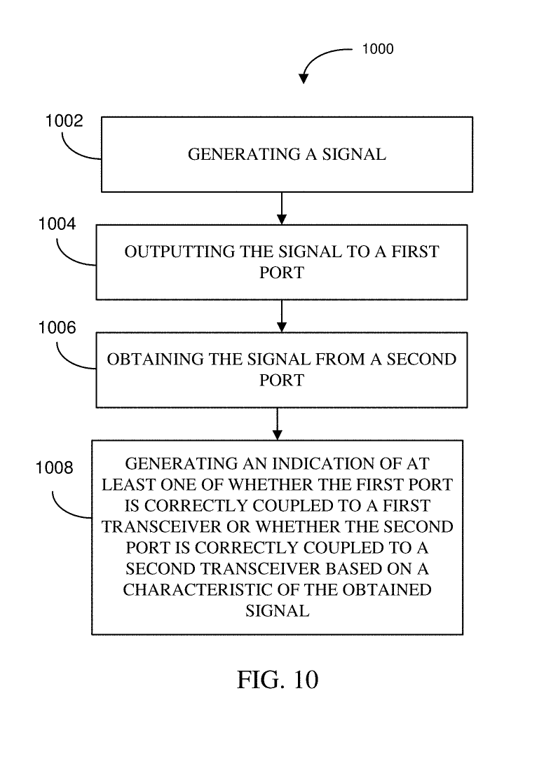

FIG. 10 illustrates an illustrative method 1000 for wireless communication. The method 1000 includes generating a signal (block 1002). The method 1000 further includes outputting the signal to a first port (block 1004). Additionally, the method 1000 includes obtaining the signal from a second port (block 1006). And, the method 1000 includes generating an indication of at least one of whether the first port is correctly coupled to a first transceiver or whether the second port is correctly coupled to a second transceiver based on a characteristic of the obtained signal (block 1008).

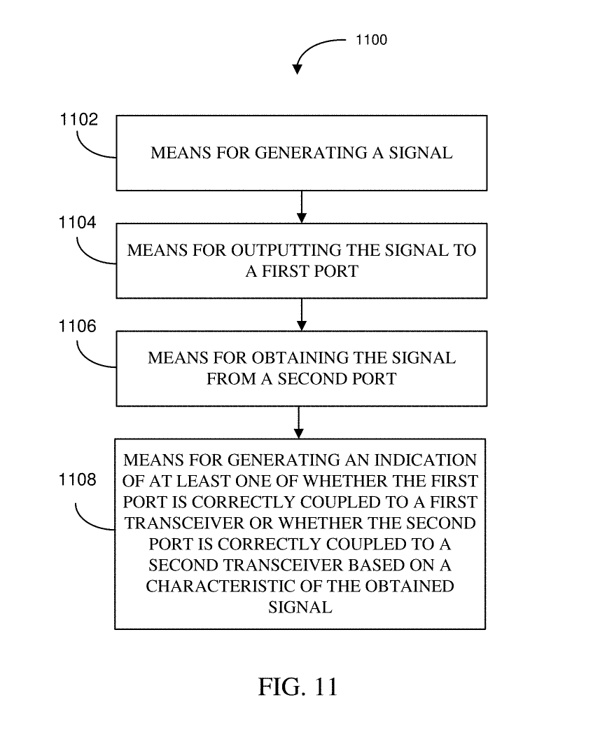

FIG. 11 illustrates exemplary means 1100 for wireless communication, including means 1102 for generating a signal. Such means 1102 includes, for example, at least one of the data source 215, the transmit data processor 220, frame builder 222, transmit processor 224, controller 234, memory device 236, the data source 255, the transmit data processor 260, the frame builder 262, the transmit processor 264, the test controller 410, the digital baseband 322, or the processing system 1220.

The means 1100 further includes means 1104 for outputting the signal to a first port. Such means 1104 includes, for example, at least one of the transmit processor 224, the transmit processor 264, the digital baseband 322, the test controller 410, or the transmit/receive interface 1230.

Additionally, the means 1100 includes means for 1106 obtaining the signal from a second port. Such means 1106 includes, for example, at least one of the receive processor 244, the receive processor 282, the digital baseband 322, the test controller 410, or the transmit/receive interface 1230.

And, the means 1100 includes means 1108 for generating an indication of at least one of whether the first port is correctly coupled to a first transceiver or whether the second port is correctly coupled to a second transceiver based on a characteristic of the obtained signal. Such means 1108 includes, for example, at least one of the controller 234, the controller 274, the test controller 410, or the processing system 1220.

The means 1100 may further include means for instructing a user to couple at least one waveguide to at least one pair of ports. Such means includes, for example, at least one of the controller 234, the controller 274, the test controller 410, the test port 412, the processing system 1220, or the user interface 1240. Further, the means 1102, 1104, 1106, and 1108 may be configured to perform similar operations with respect to additional test signals and additional ports.

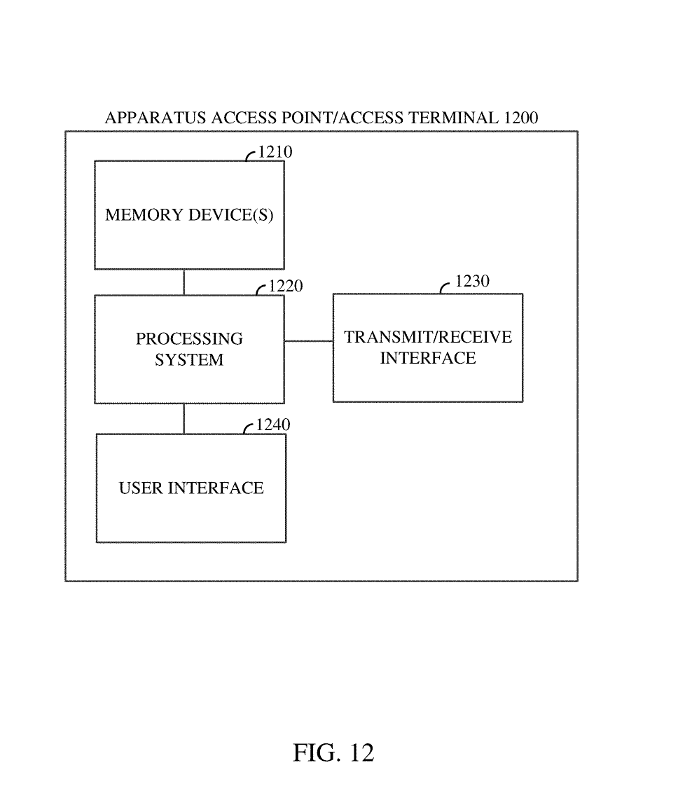

FIG. 12 illustrates an example device 1200 according to certain aspects of the present disclosure. The device 1200 may be configured with the self-testing described herein and further configured to operate in an access point (e.g., access point 110) or an access terminal (e.g., access terminal) and to perform one or more of the operations described herein. The device 1200 includes a processing system 1220, and a memory device(s) 1210 coupled to the processing system 1220. In the example of the access point 110, the processing system 1220 may include one or more of the transmitter (TX) data processor 220, the frame builder 222, the TX processor 224, the controller 234, the receiver (RX) data processor 244, and the RX processor 242. Still referring to the example of the access point 110, the memory device(s) 1210 may include one or more of the memory device(s) 236 and the data sink 246. Still referring to the example of the access point 110, the transmit/receive interface may include one or more of the bus interface, the TX data processor 220, the TX processor 224, the RX data processor 244, the RX processor 242, the transceivers 226a through 226n, and the antennas 230a through 230n.

In the example of the access terminal 120, the processing system 1220 may include one or more of the TX data processor 260, the frame builder 262, the TX processor 264, the controller 274, the RX data processor 284, and the RX processor 282. Still referring to the example of the access terminal 120, the memory device(s) 1210 may include one or more of the memory device(s) 276 and the data sink 286. Still referring to the example of the access terminal 120, the transmit/receive interface 1230 may include one or more of the bus interface, the TX data processor 260, the TX processor 264, the RX data processor 284, the RX processor 282, the transceivers 266a through 266n, and the antennas 270a through 270n.

The memory device(s) 1210 may store instructions that, when executed by the processing system 1220, cause the processing system 1220 to perform one or more of the operations described herein. Exemplary implementations of the processing system 1220 are provided below. The device 1200 also comprises transmit/receive circuitry, which may be referred to herein as a transmit/receive interface 1230, coupled to the processing system 1220. The transmit/receive interface 1230 (e.g., interface bus) may be configured to interface the processing system 1220 to a radio frequency (RF) front end, or transmit/receive interface 1230, as discussed further below.

In certain aspects, the processing system 1220 may include one or more of the following: a transmit data processor (e.g., transmit data processor 220 or 260), a frame builder (e.g., frame builder 222 or 262), a transmit processor (e.g., transmit processor 224 or 264) and/or a controller (e.g., controller 234 or 274) for performing one or more of the operations described herein. In these aspects, the processing system 1220 may generate a frame and output the frame to the RF front end for wireless transmission (e.g., to an access point or an access terminal).

In certain aspects, the processing system 1220 may include one or more of the following: a receive processor (e.g., receive processor 242 or 282), a receive data processor (e.g., receive data processor 244 or 284) and/or a controller (e.g., controller 234 and 274) for performing one or more of the operations described herein. In these aspects, the processing system 1220 may receive a frame from the RF front end and process the frame according to any one or more of the aspects discussed above.

In the case of an access terminal 120, the device 1200 may include a user interface 1240 coupled to the processing system 1220. The user interface 1240 may be configured to receive data from a user (e.g., via keypad, mouse, joystick, etc.) and provide the data to the processing system 1220. The user interface 1240 may also be configured to output data from the processing system 1220 to the user (e.g., via a display, speaker, etc.). In this case, the data may undergo additional processing before being output to the user. In the case of an access point 110, the user interface 1240 may be omitted.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and the bus interface. The bus interface may be used to connect a network adapter, among other things, to the processing system via the bus. The network adapter may be used to implement the signal processing functions of the physical (PHY) layer. In the case of an access terminal 120 (for example, see FIGS. 1, 2, and 12), a user interface (e.g., keypad, display, mouse, joystick, etc.) may also be connected to the bus interface. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by an access terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that an access terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
a processing system configured to generate a first signal; and
an interface configured to:
output the first signal to a first port; and
obtain the first signal from a second port;
wherein the processing system is further configured to generate an indication of at least one of whether the first port is correctly coupled to a first transceiver or whether the second port is correctly coupled to a second transceiver based on a characteristic of the obtained first signal.

2. The apparatus of claim 1, wherein the characteristic of the first signal comprises a propagation time of the first signal from the first port to the second port.

3. The apparatus of claim 2, wherein the propagation time comprises at least one of a time-of-departure (TOD) or a time-of-arrival (TOA) of the first signal.

4. The apparatus of claim 1, wherein the characteristic of the first signal comprises an attenuation of the first signal as it propagates from the first port to the second port.

5. The apparatus of claim 1, wherein the processing system is configured to instruct a user to couple a first waveguide to the first port and the second port, wherein the first signal propagates from the first port to the second port via the first waveguide.

6. The apparatus of claim 1, wherein the processing system is further configured generate a second signal, wherein the interface is further configured to output the second signal to the first port and obtain the second signal from a third port, wherein the generation of the indication is further based on a characteristic of the obtained second signal.

7. The apparatus of claim 6, wherein the processing system is configured to:
instruct a user to couple a first waveguide to the first port and the second port, wherein the first signal propagates from the first port to the second port via the first waveguide; and
instruct the user to couple a second waveguide to the first port and the third port, wherein the second signal propagates from the first port to the third port via the second waveguide.

8. The apparatus of claim 7, wherein the second waveguide has a length that is different from the first waveguide.

9. The apparatus of claim 6, wherein the characteristic of the first signal comprises at least one of a time-of-arrival (TOA) or a time-of-departure (TOD) of the first signal, and wherein the characteristic of the second signal comprises at least one of a TOA or a TOD of the second signal.

10. The apparatus of claim 1, wherein the processing system is configured to configure the first transceiver connected to the first port for transmission of the first signal, and the second transceiver connected to the second port for reception of the first signal.

11. A method for wireless communication, comprising:
generating a first signal;
outputting the first signal to a first port;
receiving the first signal from a second port; and
generating an indication of at least one of whether the first port is correctly coupled to a first transceiver or whether the second port is correctly coupled to a second transceiver based on a characteristic of the obtained first signal.

12. The method of claim 11, wherein the characteristic of the first signal comprises a propagation time of the first signal from the first port to the second port.

13. The method of claim 12, wherein the propagation time comprises at least one of a time-of-departure (TOD) or a time-of-arrival (TOA) of the first signal.

14. The method of claim 11, wherein the characteristic of the first signal comprises an attenuation of the first signal as it propagates from the first port to the second port.

15. The method of claim 11, further comprising instructing a user to couple a first waveguide to the first port and the second port, wherein the first signal propagates from the first port to the second port via the first waveguide.

16. The method of claim 11, further comprising:
generating a second signal;
outputting the second signal to the first port; and
obtaining the second test signal from the third port;
wherein generating the indication comprises generating the indication based on a characteristic of the obtained second signal.

17. The method of claim 16, further comprising:
instructing a user to couple a first waveguide to the first port and the second port, wherein the first signal propagates from the first port to the second port via the first waveguide; and
instructing the user to couple a second waveguide to the first port and the third port, wherein the second signal propagates from the first port to the third port via the second waveguide.

18. The method of claim 17, wherein the second waveguide has a length that is different from the first waveguide.

19. The method of claim 16, wherein the characteristic of the first signal comprises at least one of a time-of-arrival (TOA) or a time-of-departure (TOD) of the first signal, and wherein the characteristic of the second signal comprises at least one of a TOA or TOD of the second signal.

20-31. (canceled)

32. A wireless node, comprising:
a processing system configured to generate a signal;
a first transceiver configured to:
receive the signal via a first port; and
transmit the signal; and
a second transceiver configured to:
receive the transmitted signal; and
send the received signal to a second port;
wherein the processing system is further configured to obtain the signal from the second port and generate an indication of at least one of whether the first port is correctly coupled to the first transceiver or whether the second port is correctly coupled to the second transceiver based on a characteristic of the obtained signal.
